(19) United States
(12) Patent Application Publication
(10) Pub. No.: US 2002/0111953 A1
(43) Pub. Date: Aug. 15, 2002

(54) Docketing system

(75) Inventor: Cecily Anne Snyder, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First to File, Inc., Menlo Park, CA

(21) Appl. No.: 09/996,341

(22) Filed: Nov. 27, 2001

Related U.S. Application Data
(60) Provisional application No. 60/309,199, filed on Jul. 31, 2001.
(60) Provisional application No. 60/253,360, filed on Nov. 27, 2000.

(51) Int. Cl. G06F 7/00

(52) U.S. Cl. 707/101

(57) ABSTRACT

A docketing system for recording, tracking, and reporting deadlines associated with legal cases. The docketing system is useful for intellectual property practitioners, such as patent attorneys, who have to keep track of several deadlines related to intellectual property cases. According to an embodiment of the present invention, the docketing system keeps track of deadlines related to one or more cases handled by one or more practitioners. In response to events related to the cases which result in one or more deadlines, the present invention automatically generates messages notifying users of deadlines associated with the events. The docketing messages are then automatically communicated to appropriate recipients.

### CROSS-REFERENCES TO RELATED APPLICATIONS

This application claims priority to the following applications, the entire contents of which are herein incorporated by reference for all purposes:

(1) U.S. Provisional Application No. 60/253,360, entitled “DATA PROCESSING SYSTEM FOR MANAGING INTELLECTUAL PROPERTY” filed Nov. 27, 2000; and

(2) U.S. Provisional Application No. 60/309,199, entitled “DOCKETING SYSTEM” filed Jul. 31, 2001.

This application also incorporates by reference for all purposes the entire contents of the following applications:

(1) U.S. Non-Provisional Application No. 09/585,989, entitled “COMPUTER-IMPLEMENTED METHOD OF DOCKETING INTELLECTUAL PROPERTY FILINGS” filed Jun. 2, 2000;

(2) U.S. Non-Provisional Application No. 09/642,619, entitled “COMPUTER-IMPLEMENTED METHOD OF DOCKETING INTELLECTUAL PROPERTY FILINGS” filed Aug. 17, 2000; and

(3) U.S. Provisional Application No. 60/309,311, entitled “COMPUTER IMPLEMENTED METHOD OF TRACKING CORRESPONDENCE RECEIVED IN ELECTRONIC FORMAT” filed Jul. 31, 2001.

### COPYRIGHT

A portion of the disclosure of this patent document contains material that is subject to copyright protection. The copyright owner has no objection to the xerographic reproduction by anyone of the patent document or the patent disclosure in exactly the form it appears in the U.S. Patent and Trademark Office patent file or records, but otherwise reserves all copyright rights whatsoever.

### BACKGROUND OF THE INVENTION

The present invention relates to systems for managing calendar-based deadlines, and more particularly to techniques for recording, tracking, and reporting out deadlines for performing actions in legal cases including intellectual property cases.

As the world economy has become more information and technology oriented, patents and other intellectual property are of growing importance. In order to secure such intellectual property rights appropriate paperwork needs to be completed and filed in an intellectual property office. For example, in order to secure patent protection within the United States, a patent application describing and claiming an invention needs to be filed in the United States Patent and Trademark Office (hereinafter “USPTO”). Once filed, previously established rules and guidelines are followed by a Patent Examiner to determine whether or not patent rights to the invention should be granted.

Typically, the process of obtaining intellectual property rights (e.g., patents, trademarks, copyrights, etc.) involves multiple communications between the intellectual property office (e.g., the USPTO for patent and trademark rights) and a practitioner (e.g., an attorney, a patent agent, etc.) who is helping a client secure the patent rights. For purposes of this application, the word “practitioner” is intended to include an attorney, an agent, or any other individual or person authorized to represent a client in legal cases including intellectual property cases. For example, patent practitioners may include patent attorneys, patents agents, foreign attorneys dealing with patent cases, foreign patent agents, and the like.

As part of the process of securing patent rights, a patent practitioner representing a client applicant typically has to respond to communications received from the intellectual property office such as the USPTO within a given time period. The time period to respond is usually imposed by statutes, rules, and/or regulations governing time limits imposed by the intellectual property office or other governmental agencies. Failure to respond within the time period can have detrimental consequences including having to pay additional fees, or leading to the loss of intellectual property rights altogether. For example, in patent prosecution matters handled by the USPTO, a response to an Office Action mailed by the USPTO has to be filed within 3 months from the mailing date of the Office Action. If no response is filed within 3 months, the USPTO allows extensions up to an additional 3 months by paying extension fees for each additional month of extension. The patent application is however considered abandoned resulting in loss of patent rights if the response is not filed within the statutory six month time period (3 months of response time plus 3 months of extensions) from the mailing date of the Office Action.

Further, failure to respond to a deadline may subject the patent practitioner and his/her law firm to malpractice lawsuits. Accordingly, a practitioner dealing with intellectual property cases, as part of his or her duty in representing a client, has to keep track of all deadlines related to client matters and has to respond to the deadlines in a timely manner to avoid compromising the client's intellectual property rights. The situation is further complicated when the practitioner deals with intellectual property offices in foreign countries that impose their own separate set of deadlines based upon rules and regulations of the foreign countries. The problem of keeping track of deadlines is particularly acute for patent practitioners who customarily handle a large number of separate patent-related cases and are forced to track deadlines for the cases being handled.

As is evident from the above, it is impractical if not impossible for a practitioner working on intellectual property matters to rely on his/her memory to keep track of all relevant deadlines. Consequently, calendar-based deadline tracking systems (referred to as “docketing systems”) have been developed to assist practitioners in keeping track of deadlines.

According to one conventional docketing system, all correspondence that is either received from or mailed to an intellectual property office (e.g., the USPTO) by a law firm is forwarded to one or more docketing clerks who manually store information related to the correspondence in a central database. A paper report is then generated on a periodic basis (e.g., weekly, monthly, etc.) based upon data stored in the database that lists pending deadlines for one or more intellectual property practitioners affiliated with the law firm. The paper report is then forwarded to each individual practitioner and may be used by the practitioner to keep track of the deadlines. However, such a system is error-prone. Since the paper reports are generated only at pre-determined times, the paper report may not reflect the latest status of deadlines for a practitioner (e.g., the report does not reflect deadlines associated with correspondence received or mailed to the intellectual property office between the pre-determined times). Further, since the paper report has to be routed from the location (e.g., a docketing office) where the report is generated to the practitioner's office, the report can get delayed or even lost in the routing process. The paper report may even get lost in the reams of paperwork typically handled by an intellectual property practitioner.

According to another conventional practice, docketing system responsibilities are outsourced to docketing services such as Computer Packages Inc. (CPI) of Rockville, Md., or Computer Patent Annuities (CPA). These services, however, do not interface well with law firms, technology developers, intellectual property offices, and other entities involved in the process of securing intellectual property rights.

Accordingly, based upon the above, improved docketing systems and processes are desirable.

### BRIEF SUMMARY OF THE INVENTION

Embodiments of the present invention pertain to a docketing system for recording, tracking, and reporting deadlines associated with legal cases. The docketing system is useful for intellectual property practitioners, such as patent attorneys, who have to keep track of several deadlines related to intellectual property cases. According to an embodiment of the present invention, the docketing system keeps track of deadlines related to one or more cases handled by one or more practitioners. In response to events related to the cases which result in one or more deadlines, the present invention automatically generates messages notifying users of deadlines associated with the events. The docketing messages are then automatically communicated to appropriate recipients.

According to an embodiment of the present invention, techniques are provided for generating a message for a first intellectual property case. In this embodiment, information related to a plurality of intellectual property cases is stored on a computer-readable medium, the plurality of intellectual property cases including the first intellectual property case. The docketing system receives a signal indicating occurrence of an event related to the first intellectual property case. Responsive to receiving the signal, the docketing system identifies one or more rules associated with the event. The docketing system then identifies at least a first rule from the one or more rules based upon filter criteria information associated with the one or more rules and based upon information related to the first intellectual property case stored on the computer-readable medium. The docketing system generates at least one message using the at least first rule, the message identifying an action to be performed in response to the event and identifying a date associated with the action, and the at least one message is communicated to a first designated client system.

The foregoing, together with other features, embodiments, and advantages of the present invention, will become more apparent when referring to the following specification, claims, and accompanying drawings.

### BRIEF DESCRIPTION OF THE DRAWINGS

FIG. 1 is a simplified block diagram of a distributed system that may incorporate an embodiment of the present invention;

FIG. 2 is a simplified block diagram of a computer system according to an embodiment of the present invention;

FIG. 3 is a simplified high-level flowchart depicting a method of configuring the docketing system to generate docketing messages according to an embodiment of the present invention;

FIG. 4 is a simplified high-level flowchart depicting a method of configuring a triggering event according to an embodiment of the present invention;

FIG. 5 depicts an example of a simplified user interface for creating new triggering events according to an embodiment of the present invention;

FIG. 6 is a simplified high-level flowchart depicting a method of configuring a docket rule according to an embodiment of the present invention;

FIG. 7 depicts an example of a simplified user interface for creating a rule according to an embodiment of the present invention;

FIG. 8 depicts a simplified table listing examples of rules that may be configured according to an embodiment of the present invention;

FIG. 9 is a simplified high-level flowchart depicting a method of associating rules with a triggering event according to an embodiment of the present invention;

FIGS. 10A and 10B depict an example of a simplified user interface for associating one or more rules with a triggering event according to an embodiment of the present invention;

FIG. 11 is a simplified high-level flowchart depicting a method of generating docketing messages in response to a triggering event according to an embodiment of the present invention;

FIG. 12 depicts an example of a simplified user interface for outputting docketing messages to a user according to an embodiment of the present invention;

FIG. 13 is a simplified high-level flowchart showing a method of modifying a previously configured rule according to an embodiment of the present invention;

FIG. 14 is a simplified high-level flowchart showing a method of deleting a previously configured rule according to an embodiment of the present invention;

FIG. 15 is a simplified high-level flowchart depicting a method of modifying a previously configured triggering event according to an embodiment of the present invention; and

FIG. 16 is a simplified high-level flowchart showing a method of deleting a previously configured triggering event according to an embodiment of the present invention.

### DETAILED DESCRIPTION OF THE INVENTION

The present invention provides a docketing system for recording, tracking, and reporting deadlines associated with legal cases. The docketing system is useful for intellectual property practitioners, such as patent attorneys, who have to keep track of several deadlines related to intellectual property cases. As described above, for purposes of this application, the word “practitioner” is intended to include an attorney, an agent, or any other individual or person authorized to represent a client in legal cases including intellectual property cases. For example, patent practitioners may include patent attorneys, patents agents, foreign attorneys dealing with patent cases, foreign patent agents, and the like.

According to an embodiment of the present invention, the docketing system keeps track of deadlines related to one or more cases handled by one or more practitioners.

In response to events related to the one or more cases which result in one or deadlines (e.g., when correspondence is mailed to or received from an intellectual property office like the USPTO), the present invention automatically generates messages notifying users of deadlines associated with the events. The docketing messages are then automatically communicated to their appropriate recipients, who may be intellectual property practitioners (e.g., patent attorneys, agents, foreign associates, etc.) and other individuals involved in the process of securing intellectual property rights such as inventors, patent coordinators, paralegals, legal secretaries, workflow managers, and the like. In this manner, the present invention eliminates the error-prone task of generating periodic paper reports. According to an embodiment of the present invention, the docketing system interfaces with electronic interfaces provided by intellectual property offices and integrates information received from or sent to the intellectual property offices with the docketing process.

For convenience, one embodiment of the present invention is described below that provides docketing services for patent-related cases. It should however be apparent that the docketing system according to the teachings of the present invention may be used in any environment, system, or application that involves tracking, recording, and reporting of calendar-based deadlines. For example, in addition to patent-related cases, the docketing system may also be used to provide docketing services for trademark-related cases, copyright-related cases, litigation cases, and the like. Accordingly, the description of the present invention set forth below is not intended to limit the scope of the present invention in any way. One of ordinary skill in the art would recognize variations, modifications, and alternatives.

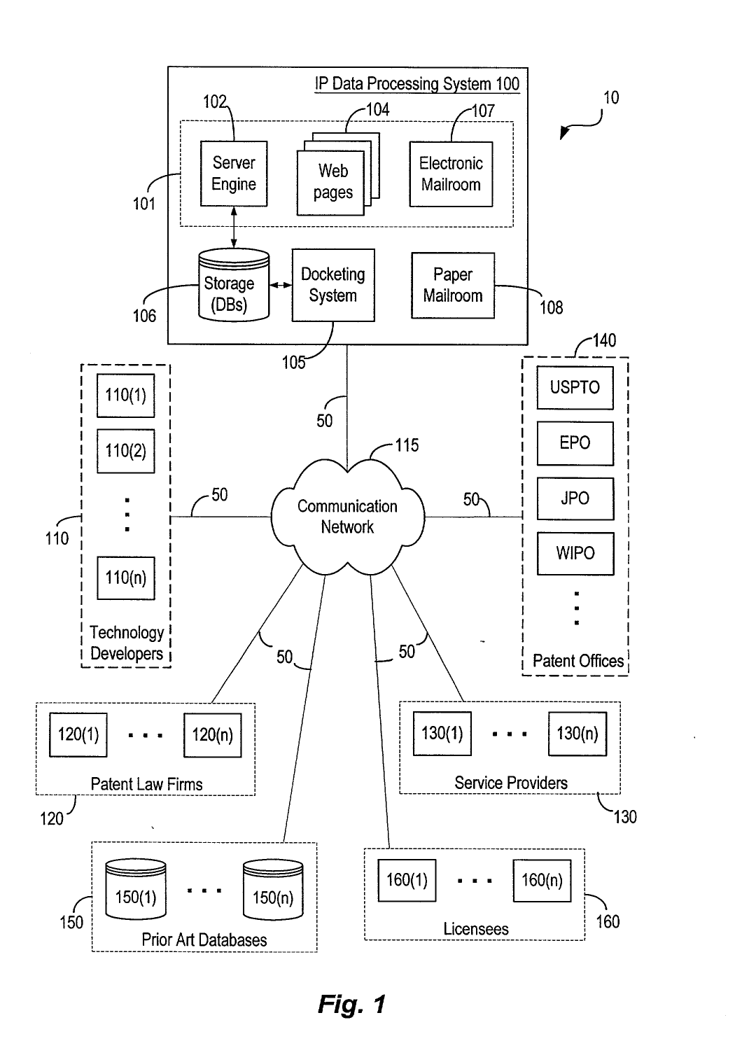

FIG. 1 is a simplified block diagram of a distributed system 10 that might incorporate an embodiment of the present invention. As depicted in FIG. 1, distributed system 10 includes a docketing system (DS) 105 that provides docketing services according to the teachings of the present invention. According to the embodiment depicted in FIG. 1, DS 105 may be part of an intellectual property (IP) data processing system 100 that may be used by participants in the patent process to secure patent rights. According to an embodiment of the present invention, IP data processing system 100 is a Web-enabled electronic platform that can be utilized by all participants in the patent process to convert the traditional paper-based patent prosecution system into an electronic workflow pipeline that allows every step in the process to be executed from a computer desktop.

As depicted in FIG. 1, various other devices or computer systems belonging to participants in the process of securing and/or exploiting patent rights may be coupled to DS 105 via communication network 115 and communication links 50. These systems include systems of technology developers 110, patent law firms 120, service providers 130, patent offices 140, prior art databases 150, potential licensees 160, and the like. For convenience, each of the participants depicted in FIG. 1 is referenced by a dotted line that encompasses individual entities and systems of the participant type. For example, technology developers 110 are shown in FIG. 1 as including individual technology developers 110(1), 110(2), through 110(n). It is to be understood that, while shown in FIG. 1 as a group, these multiple technology developers are separate entities that likely have no relation to each other than their classification within this patent application as developers of technology.

It should be apparent that distributed system 10 depicted in FIG. 1 is merely illustrative of an embodiment incorporating the present invention and does not limit the scope of the invention as recited in the claims. One of ordinary skill in the art would recognize other variations, modifications, and alternatives. For example, in alternative embodiments of the present invention, DS 105 may be deployed in various other environments such as an enterprise environment, a stand-alone system, and the like.

Communication network 115 provides a mechanism allowing the various devices and computer systems depicted in FIG. 1 to communicate and exchange data and information with each other. Communication network 115 may itself be comprised of many interconnected computer systems and communication links. While in one embodiment, communication network 115 is the Internet, in other embodiments, communication network 115 may be any suitable communication network including a local area network (LAN), a wide area network (WAN), a wireless network, an intranet, a private network, a public network, a switched network, an enterprise network, a virtual private network, and the like.

Communication links 50 that are used to connect the various systems depicted in FIG. 1 may be of various types including hardwire links, optical links, satellite or other wireless communications links, wave propagation links, or any other mechanisms for communication of information. Various communication protocols may be used to facilitate communication of information via communication links 50. These communication protocols may include TCP/IP, HTTP protocols, extensible markup language (XML), wireless application protocol (WAP), protocols under development by industry standard organizations, vendor-specific protocols, customized protocols, and others.

Technology developers 110 may include corporations, universities, individual inventors, and other like entities seeking to file patent applications and receive issued patents. For example, technology developers may include inventors, in-house patent practitioners, in-house patent administrator, and the like. Patent law firms 120 may include patent practitioners such as U.S. patent attorneys, patent agents, foreign patent attorneys and/or agents, and other individuals such as patent secretaries, paralegals, legal assistants, docketing personnel, workflow coordinators, etc., that help technology developers to secure patent rights. Service providers 130 may include patent draftspersons, prior art search companies, translation companies, and other entities that provide services useful to the patent process as well as financial institutions and other parties that have tangential roles in the process. Prior art databases 150 may include public and licensed private databases, such as online patent databases (e.g., issued U.S. patents, published U.S. applications, published European and Japanese patents, published PCT applications, and other publications) and non-patent databases. Patent offices 140 may include intellectual property offices and government agencies that are authorized to grant patent rights. These intellectual property offices may include the USPTO, the European Patent Office (EPO), the Japanese Patent Office (JPO), the Taiwanese Patent Office, etc.

As stated above, DS 105 provides docketing services for patent-related cases. According to an embodiment of the present invention, DS keeps track of deadlines related to one or more patent cases handled by one or more patent practitioners. In response to events which result in one or deadlines (e.g., when correspondence is mailed to or received from an intellectual property office like the USPTO), DS 105 automatically generates docketing messages identifying actions to be performed in response to the events and dates associated with the actions. The docketing messages are then automatically communicated to the appropriate recipients, who may be intellectual property practitioners and others involved in securing intellectual property rights. According to an embodiment of the present invention, DS 105 interfaces with electronic interfaces provided by intellectual property offices and integrates information received from or sent to the intellectual property offices with the docketing process.

As shown in FIG. 1, according to an embodiment of the present invention, DS 105 may be implemented as part of an intellectual property (IP) data processing system 100 that may be used by participants in the patent process to secure patent rights. As shown in FIG. 1, IP data processing system 100 includes a server 101 (e.g., a Web server), a data storage repository such as database 106, and a paper mailroom 108. Server 101 may include a server engine 102 that is configured to generate and communicate documents including web pages 104 to other systems coupled to IP data processing system 100. These web pages may be viewed by other systems of the participants depicted in FIG. 1 using a browser application program executing on systems of the participants. Server 101 may also include an electronic mailroom 107.

Database 106 stores information related to the patent process. For example, database 106 may store information pertaining to the technology developers' intellectual property portfolios. The information in database 106 may include draft and completed invention disclosures, draft and completed patent application documents, draft and completed prosecution filings (e.g., amendments), information about discussions pertaining to invention disclosures and patent applications, patent and patent application status information, prior art publications, office actions, assignment papers, other forms and papers filed in or generated by a patent office, etc. According to an embodiment of the present invention, information used by DS 105 for providing docketing services may be stored by database 106. In alternative embodiments, DS 105 may itself store the information.

Patent process participants (such as technology developer employees, outside law firm personnel, etc.) may access the information stored in database 106 as needed and only to the extent that their access rights permit. The information stored in database 106 may be shared between participants on an as-allowed basis. For example, a technology developer 110 and an appropriate patent law firm(s) 120 servicing the technology developer may share data related to invention disclosures, patent filings, patent prosecution related information and filings, and other like information.

IP data processing system 100 may communicate with patent offices 140 using electronic mailroom 107 and/or using paper mailroom 108 that uses standard mail (e.g., U.S. Postal Office First Class and Express Mail). Electronic mailroom 107 may include a suite of programs that interface with programs provided by one or more patent offices 140. For example, in order to file patent applications electronically through the USPTO, the system comports to the standards required by the USPTO's Electronic Filing System (EFS). This includes using the Electronic Packaging and Validation Engine (ePAVE) or compatible software to facilitate electronic filing. Complete details of the ePAVE software are available online through the USPTO's Electronic Business Center Web site at http://pto-ebc.uspto.gov/. Also, in order to track and update status information for pending patent applications, such as Examiner name, assigned art unit and class/subclass, etc., electronic mailroom 107 may have the ability to interface to the USPTO's Patent Application Information Retrieval (PAIR) system using appropriate digital certificates. Electronic mailroom 107 may also include other programs to interface with other patent offices. The information received from the patent offices by electronic mailroom 107 may be used by DS 105 to provide docketing services.

Paper mailroom 108 may include printers, fax machines, fax servers and other appropriate equipment for filing patent applications, responses, and other formal papers with the patent offices using standard mailing procedures. Paper mailroom 108 may also include scanners and other equipment that can be used to scan papers and other correspondence received from technology developers 110, patent practitioners or law firms 120, and patent offices 140 into computer-readable format. The scanned documents may then be subjected to optical character recognition (OCR) analysis to extract information from the scanned documents. For example, OCR analysis may be used to recognize particular fields from the scanned documents such as title of a patent application, an application number assigned by the USPTO, a patent examiner's name, the type of the document (e.g., an Office Action, a Notice of Allowance, a patent application, etc.), applicant information, assignee information, date of mailing of a correspondence received from a patent office, and other like information. The information extracted from OCR analysis may be stored in database 106 along with the scanned documents. Alternatively, or in addition to such scanning, personnel in paper mailroom 108 can directly enter appropriate data into database 106 using computers or data entry terminals coupled to the database through a local area network or similar network. The information extracted from the scanned documents or information entered by personnel in paper mailroom 108 may be used by DS 105 to provide docketing services.

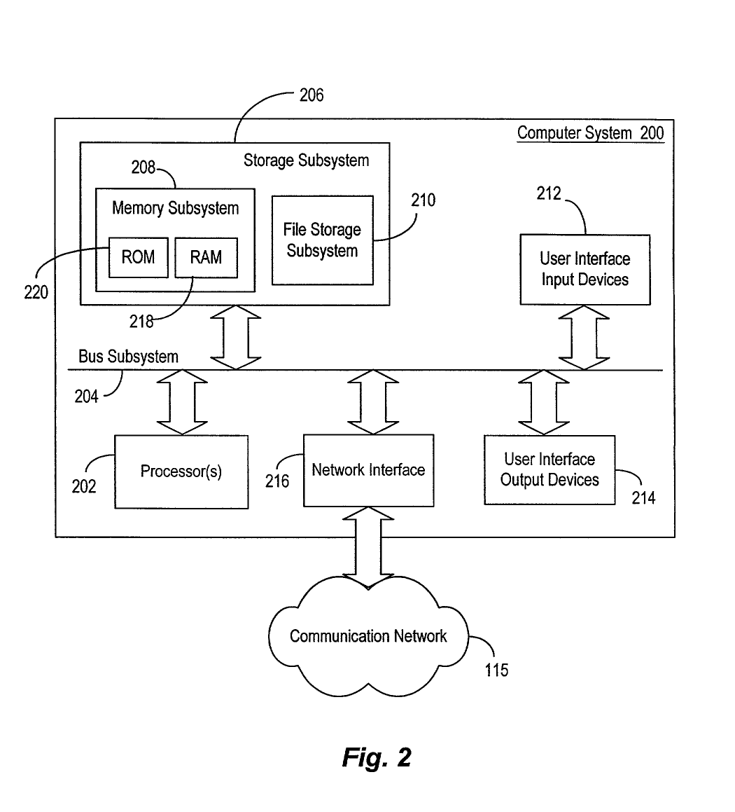

The computer systems depicted in FIG. 1 may be of the form depicted in FIG. 2. FIG. 2 is a simplified block diagram of a computer system 200 according to an embodiment of the present invention. As shown in FIG. 2, computer system 200 includes at least one processor 202 that communicates with a number of peripheral devices via a bus subsystem 204. These peripheral devices may include a storage subsystem 206, comprising a memory subsystem 208 and a file storage subsystem 210, user interface input devices 212, user interface output devices 214, and a network interface subsystem 216. The input and output devices allow user interaction with computer system 200. A user may be a human user, a device, a process, another computer, and the like. Network interface subsystem 216 provides an interface to other computer systems and communication networks including communication network 115.

Bus subsystem 204 provides a mechanism for letting the various components and subsystems of computer system 200 communicate with each other as intended. The various subsystems and components of computer system 200 need not be at the same physical location but may be distributed at various locations within network 115. Although bus subsystem 204 is shown schematically as a single bus, alternative embodiments of the bus subsystem may utilize multiple buses.

User interface input devices 212 may include a keyboard, printing devices, a mouse, trackball, touchpad, a graphics tablet, a scanner, a barcode scanner, a touchscreen incorporated into the display, audio input devices such as voice recognition systems, microphones, and other types of input devices. In general, use of the term “input device” is intended to include all possible types of devices and ways to input information using computer system 200.

User interface output devices 214 may include a display subsystem, a printer, a fax machine, or non-visual displays such as audio output devices. The display subsystem may be a cathode ray tube (CRT), a flat-panel device such as a liquid crystal display (LCD), or a projection device. In general, use of the term “output device” is intended to include all possible types of devices and ways to output information from computer system 200.

Storage subsystem 206 may be configured to store the basic programming and data constructs that provide the functionality of the computer system and of the present invention. For example, according to an embodiment of the present invention, software modules implementing the functionality of the present invention may be stored in storage subsystem 206 of DS 105. For example, software modules that facilitate generation of messages and notifications related to deadlines may be stored in storage subsystem 206 of DS 105. These software modules may be executed by processor(s) 202 of DS 105. In a distributed environment, the software modules may be stored on a plurality of computer systems and executed by processors of the plurality of computer systems. Storage subsystem 206 may also provide a repository for storing various databases and files that may be used by the present invention. For example, the multimedia documents may be stored in storage subsystem 206. Storage subsystem 306 may comprise memory subsystem 208 and file storage subsystem 210.

Memory subsystem 208 may include a number of memories including a main random access memory (RAM) 318 for storage of instructions and data during program execution and a read only memory (ROM) 220 in which fixed instructions are stored. File storage subsystem 210 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media. One or more of the drives may be located at remote locations on other connected computers.

Computer system 200 itself can be of varying types including a personal computer, a portable computer, a workstation, a computer terminal, a network computer, a mainframe, a kiosk, a personal digital assistant (PDA), a communication device such as a cell phone, a game controller, or any other data processing system. Due to the ever-changing nature of computers and networks, the description of computer system 200 depicted in FIG. 2 is intended only as a specific example for purposes of illustrating the preferred embodiment of the computer system. Many other configurations of a computer system are possible having more or fewer components than the computer system depicted in FIG. 2. For example, several other subsystems may be included in computer system 200 depending upon the functions performed by system 200.

In a distributed system such as system 10 depicted in FIG. 1, computer systems that request data or services are classified as client computer systems while computer systems that provide the data or services requested by client computers are classified as server systems. Accordingly, the computer system(s) of IP data processing system 100, including DS 105, may be classified as server systems while computer systems of the participants may be classified as client systems. It should be apparent that a particular computer system may function both as a client system and a server system based upon whether the computer systems is requesting data and/or services or receiving data and/or services.

As can be appreciated from the above description, IP data processing system 100 provides a system to track all correspondence, communications, relevant dates and relevant events for patent applications owned by a given technology developer 110(i) or for patent applications for which a given patent law firm 120(i) is responsible for. Of course system 100 can also be used to track correspondence, communications, relevant dates and relevant events for a subset of such patent applications. For example, for all applications related to a particular technology, owned by a particular company group, owned by a particular law firm client, or filed after a particular date. In tracking such information, system 100 tracks information that is used by DS 105 to provide docketing services.

As described above, in the embodiment depicted in FIG. 1, IP data processing system 100 tracks and records information related to the various patent cases. In alternative embodiments, IP data processing system 100 may track and record information related to other cases such as trademark cases, copyright cases, litigation cases, and the like. According to an embodiment of the present invention, information related to each case is stored in a case data unit. The case may refer to a patent application, a trademark application, a copyright application, a litigation case, and the like. For purposes of the following example, it is assumed that a case refers to a patent-related case, e.g., a patent application, a patent application filed in a particular country or jurisdiction, a patent application filed according to a convention or treaty (e.g., PCT), and the like.

A case data unit stores data and/or a collection of electronic documents (or references to the electronic documents) that are related to a particular case, e.g., a patent application in a particular country. The electronic documents may include scanned copies of paper documents related to the particular case. For example, the electronic documents stored or referred to by the case data unit may include a scanned copy of an Office Action received from the USPTO. In some instances a patent case may actually include more than one patent application, for example, where a Continued Prosecution Application (CPA) is filed in the USPTO under rule 37 C.F.R. 1.53(d).

The case data unit may be implemented as a data structure, a file, a database, or any other structure capable of storing data and/or documents. In one embodiment, the data stored by a case data unit includes a variety of bibliographic information (referred to herein as “case meta data”) associated with a patent case, as well as one or more documents related to the patent case. Case meta data stored in the case data unit for a particular patent case may include, for example, a case title, a patent application number (serial number), a filing date, a patent number, a patent date, publication numbers and associated publication dates, a client reference number, a law firm reference number, the country the application is filed in, a list of inventors, a status indicator (e.g., patent application filed, issued, abandoned, etc.), an assignee, information related to the assignment (e.g., an assignment recordation date and reel and frame number), a responsible patent practitioner, a working attorney, priority information (e.g., serial numbers, filing dates and countries of any parent cases), etc.

The documents stored in or referred to by a case data unit may include a variety of documents of different document types. Specific examples of document types include an invention disclosure, a filed patent application, patent drawings, old versions of patent applications and drawings, other patent papers (e.g., other documents filed in the patent office including Responses to Office Actions, Information Disclosure Statements, Petitions, etc.), forms, image files (e.g., locked documents of .pdf or a similar type of image file format corresponding to a granted patent (if a patent was granted for the case) as well as electronic scanned copies of any office actions received, responses filed in the patent office, filing receipts, etc. received during prosecution of the patent application, notes (e.g., practitioner notes, inventor notes, notes from other interested parties regarding the importance of the patent to a companies business, products or competitors business or products, etc.), mail (e.g., email messages or alerts), and prior art references among others. It is to be understood that this list is for illustrative purposes only and various embodiments of the invention can include more or fewer document types and information as appropriate.

Each document stored in a case data unit also includes appropriate document meta-data that identifies the document and its history. Examples of document meta data include document ID, document type, originator, status, security profile, file format, creation date, last modified date, last modified by, physical file attributes, search field key words, completion date, witness names and dates, etc. The combination of a document, its document meta-data and other information related to the document may be referred to herein as a document entity.

According to an embodiment of the present invention, the case data unit may also store docketing information (e.g., notifications and docketing messages related to deadlines) generated by DS 105 for the particular patent case. In one embodiment the case data unit is presented to the client system through a trifold or similar graphical user interface.

According to an embodiment of the present invention, DS 105 automatically generates messages (referred to as “docketing messages”) for the cases in response to occurrence of events related to the cases. Each message generated by DS 105 identifies an action to be performed and identifies a date associated with the action. According to an embodiment of the present invention, the date indicated by a message generated by DS 105 may be of a particular type. Several types of dates may be configured including a reminder date, a due date, an absolute due date (also referred to as a “drop dead date”), and the like.

A “reminder date” is a date that reminds the user of an action that is to be due to be performed at some future point in time. A reminder date thus reminds a user of an action to be performed in the future, e.g., a future pending deadline.

A “due date” associated with an action is a date that indicates the latest date by which the action associated with the due date has to be performed without paying any penalties or late fees or incurring any loss of intellectual property rights. For example, a message containing a due date may indicate that a response to an Office Action in a patent application mailed Apr. 8, 2001 has to be filed by Jul. 8, 2001. The Jul. 8, 2001 is a due date for responding to the Office Action.

A “drop dead date” indicates the last possible date, including extensions available by paying penalties, late fees, etc., by which the action associated with the date has to be performed. Failure to perform the action by the drop dead date may result in loss of intellectual property rights. For example, for the Office Action mailed Apr. 8, 2001, the absolute last date to respond to the Office Action with a maximum 3 month extension is Oct. 8, 2001. The patent application is considered abandoned if the response is not filed by Oct. 8, 2001.

Reminder dates may also be referred to as “soft dates” while due dates and drop dead dates may be referred to as “hard dates”. According to an embodiment of the present invention, the different types of dates are user configurable. Reminders can be further customized to each individual user's preferences rather than be set by a group's setup.

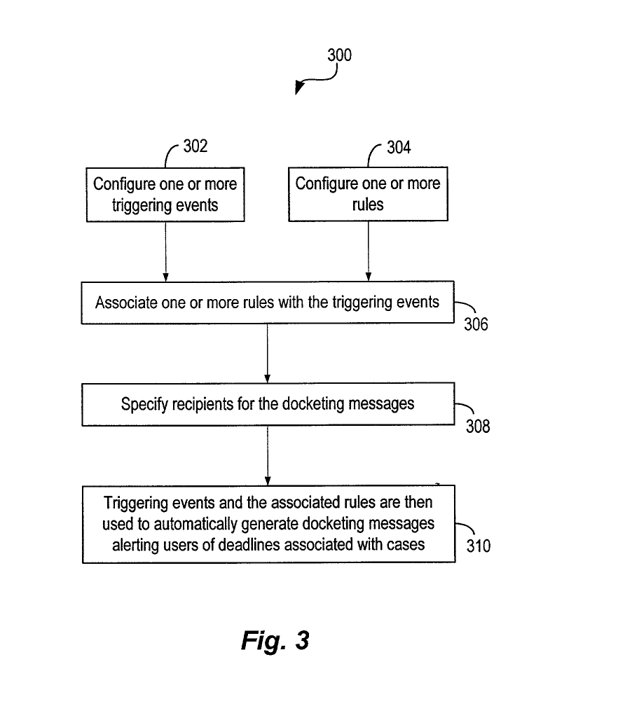

FIG. 3 is a simplified high-level flowchart 300 showing a method of configuring DS 105 to generate docketing messages according to an embodiment of the present invention. Flowchart 300 depicted in FIG. 3 is merely illustrative of an embodiment incorporating the present invention and does not limit the scope of the invention as recited in the claims. One of ordinary skill in the art would recognize other variations, modifications, and alternatives.

As depicted in FIG. 3, the method is initiated by configuring one or more triggering events (step 302) and one or more rules (step 304). Steps 302 and 304 may be performed concurrently. According to an embodiment of the present invention, a triggering event is any event that occurs in a case and which requires some action or response from a user (e.g., the patent practitioner handling the case) associated with the case. The action or response is generally required within a certain timeframe. Examples of triggering events for a U.S. patent case include filing of a patent application, receipt of a Notice to File Missing parts of a patent application, receipt of an office action for a patent application, receipt of a final office action for the patent application, issuance of a patent, and the like. In addition to events related to a case, changes in data stored in a case data unit for a case may also be configured as triggering events.

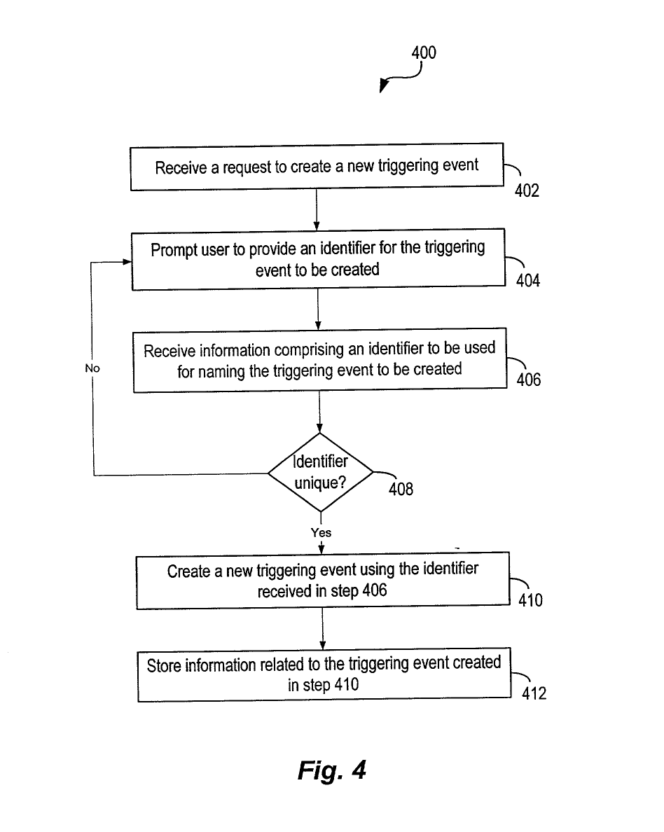

Triggering events may be defined by providers of IP data processing system 100 or may also be defined by users (e.g., other participants in the patent process) of the present invention. Information related to the triggering events may be stored in database 106 from where it can be accessed by DS 105. FIG. 4 is a simplified high-level flowchart 400 depicting a method of configuring a triggering event according to an embodiment of the present invention. Flowchart 400 depicted in FIG. 4 is merely illustrative of an embodiment incorporating the present invention and does not limit the scope of the invention as recited in the claims. One of ordinary skill in the art would recognize other variations, modifications, and alternatives.

As depicted in FIG. 4, the method is initiated when DS 105 receives a request from a user to create a new triggering event (step 402). The request may be received from a computer system belonging to one or participants in the patent process depicted in FIG. 1. For example, the request may be received from a docketing specialist from a law firm, from an in-house patent attorney, and the like. The request may also be received from a provider of IP data processing system 100.

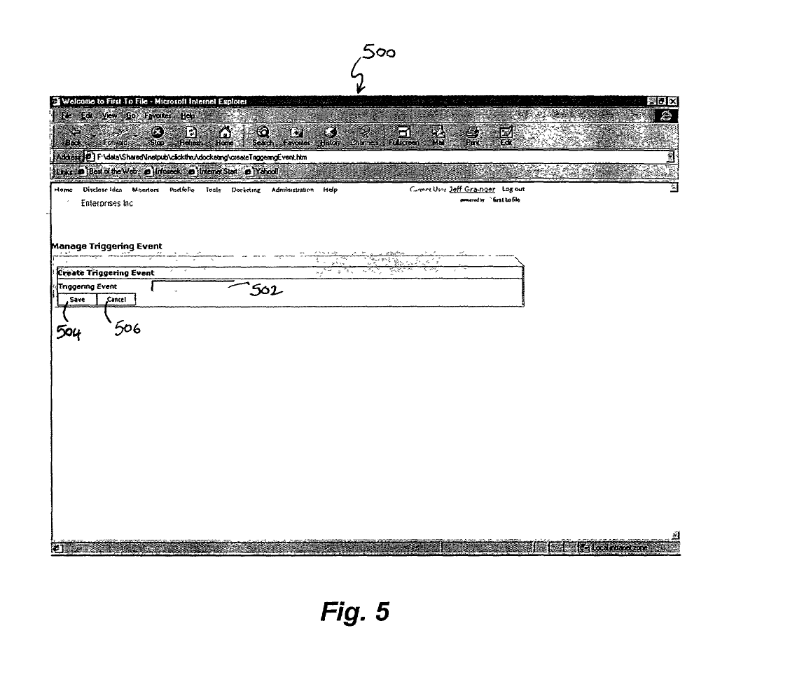

DS 105 then prompts the user to provide an identifier for the triggering event to be created (step 404). According to an embodiment of the present invention, a user interface such as user interface 500 depicted in FIG. 5 may be displayed to user. The user may enter the triggering event identifier in field 502. Selection of “Save” button 504 instructs DS 105 to create a triggering event having the name or identifier entered in field 502. The user may cancel the process of configuring a triggering event by selecting “Cancel” button 506.

DS 105 then receives information comprising the identifier to be used for naming the triggering event (step 406). DS 105 then determines if the identifier received in step 406 is unique (step 408). As part of step 408, DS 105 checks if any previously configured triggering events have the same identifier (name) as the triggering event identifier received in step 406. If a duplicate identifier is detected, processing reverts back to step 404 wherein the user is prompted to enter another identifier for the triggering event. If the triggering event identifier is determined to be unique, DS 105 then creates a new triggering event using the identifier received in step 406 (step 410). Information related to the triggering event configured in step 410 is then stored in a memory location from where it can be accessed by DS 105 (step 412).

According to an embodiment of the present invention, in step 412, information related to the user who requested creation of the triggering event is also stored along with the triggering event related information. The user information is used to ensure that the triggering event can be modified or deleted only by the user who configured the triggering event or by someone who is authorized by the user who created the triggering event.

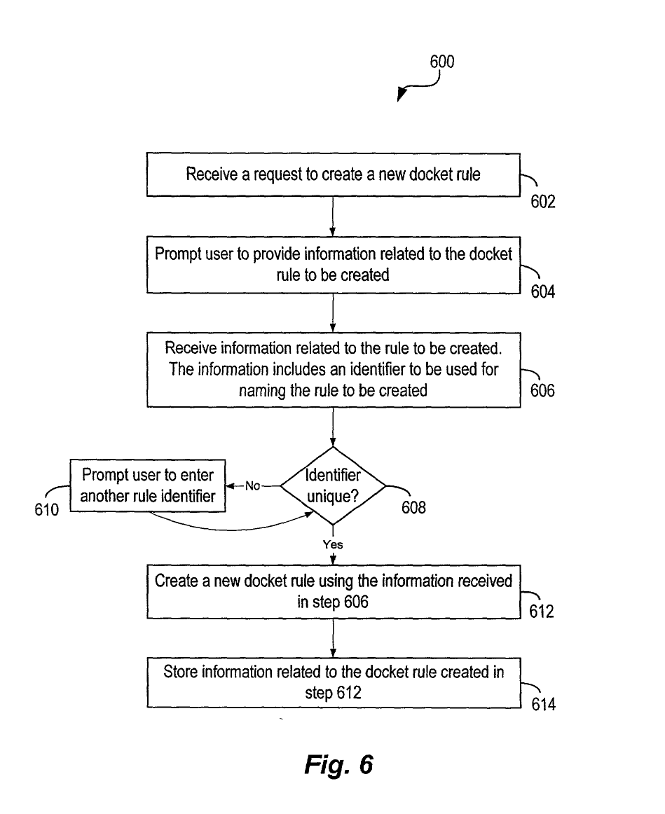

Referring back to FIG. 3, in step 304, one or more rules may be configured. Each rule comprises information for generating one or more docketing messages that are generated to alert the user that an action or response is required for a particular case in response to a triggering event. FIG. 6 is a simplified high-level flowchart 600 depicting a method of configuring a docket rule according to an embodiment of the present invention. Flowchart 600 depicted in FIG. 6 is merely illustrative of an embodiment incorporating the present invention and does not limit the scope of the invention as recited in the claims. One of ordinary skill in the art would recognize other variations, modifications, and alternatives.

As depicted in FIG. 6, the method is initiated when DS 105 receives a request from a user to create a new docket rule (step 602). The request may be received from a computer system belonging to one or participants depicted in FIG. 1. For example, the request may be received from a docketing specialist from a law firm, from an in-house patent attorney, and the like. The request may also be received from a provider of IP data processing system 100.

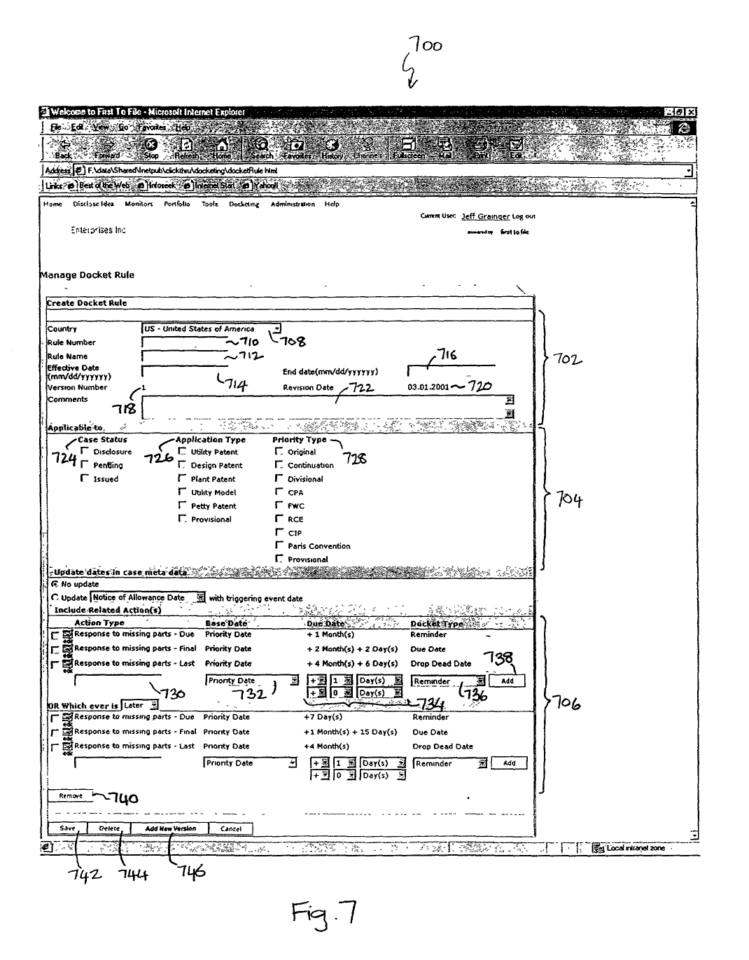

DS 105 then prompts the user to provide information related to the docket rule to be created (step 604). According to an embodiment of the present invention, a user interface such as user interface 700 depicted in FIG. 7 (described below) may be displayed to enable the user to enter information related to the rule to be created.

DS 105 then receives information provided by the user that is to be used for creating the rule (step 606). The information received in step 606 includes an identifier to be used for naming the rule. DS 105 then determines if the identifier received in step 606 is unique (step 608). As part of step 608, DS 105 checks if any previously configured docket rule has the same identifier (name) as the identifier received in step 606. If a duplicate identifier is detected, the user is prompted to enter another rule identifier (step 610). If the identifier is determined to be unique in step 608, DS 105 then creates a new docket rule using the information received in step 606 (step 612). Information related to the rule configured in step 612 is then stored in a memory location from where it can be accessed by DS 105 (step 614).

According to an embodiment of the present invention, in step 614, information related to the user who requested creation of the docket rule is also stored along with the rule information. The user information is used to ensure that the rule can be modified or deleted only by the user who configured the rule or by someone who is authorized by the user who created the rule.

FIG. 7 depicts an example of a simplified user interface 700 for creating a rule according to an embodiment of the present invention. User interface 700 depicted in FIG. 7 is merely illustrative of an embodiment of the present invention and does not limit the scope of the invention as recited in the claims. One of ordinary skill in the art would recognize other variations, modifications, and alternatives. As depicted in FIG. 7, interface 700 comprises three sections 702, 704, and 706. The fields in each of the sections are described below.

Section 702 of user interface 700 includes a field 708 wherein a user may enter a country to which the rule applies. Information used for identifying a rule may be entered in fields 710 and 712. For example, a name identifier for the rule may be entered in field 712. According to an embodiment of the present invention, DS 105 automatically generates an internal rule number or key number for the rule. A rule may have an effective period characterized by an effective date and an end date. The effective period identifies a period of time when the rule is valid and is to be applied. For example, the effective period of a rule may be based upon the filing date of a patent application. The effective date for a rule can be entered in field 714 and marks the start of the time period when the rule is effective. The end date for the rule can be entered in field 716.

According to an embodiment of the present invention, multiple versions of a rule may be stored. The current version of the rule is indicated in field 718. The revision date 720 for each version is also indicated. Comments related to the rule can be entered in field 722.

Section 704 of user interface 700 provides fields for specifying attributes of a case that have to be satisfied in order for the rule to be applied for the case. The information entered in section 704 thus identifies criteria (referred to as “filter criteria”) that are used to determine if a particular rule is applicable for a particular case. According to an embodiment of the present invention depicted in FIG. 7, the user can select a status 724 of the case to which the rule is to apply. For example, the user may specify if the rule is to be applied to a disclosure (i.e., to a case that has not been filed as yet), to a pending patent application, or to an issued patent. The application type 726 to which the rule is to be applied may also be specified. For example, the rule may be applied to a utility patent case, a design patent case, a plant patent case, a utility model patent case, a petty patent case, a provisional patent application case, and the like. The priority type 728 of a case to which the rule is to apply may also be specified. As will be explained below, DS 105 uses this information to identify whether a particular rule is to be applied to a particular case.

Section 706 provides fields for specifying information that is used to generate docketing messages according to an embodiment of the present invention. As described above, each docketing message comprises information identifying an action to be performed and a date associated with the action. Accordingly, in section 706, a user may specify actions (or descriptions of actions) to be associated with the rule. For example, a user can input information identifying an action to be associated with the rule in field 730.

The user may also specify a formula to be used for generating a date to be associated with each action specified for the rule. According to an embodiment of the present invention, the date generation formula is generally a mathematical formula that takes as input a “base date” and calculates a date to be associated with the action based upon the base date. The base date may correspond to a date when a triggering event occurred, or some other date indicated in the information stored in the case data unit for a case, or some other date. The date generation formulae are generally based upon legal rules, statutes, or regulations applicable to the triggering event. For example, a base date may correspond to the date of filing of an application, the priority date for an application, the date of mailing of correspondence from the patent office, and the like. The date generation formula may also be based upon preferences configured by users of the present invention. According to an embodiment of the present invention, date generation formulae used for generating soft dates are usually based upon user preferences while formulae for calculating hard dates are usually based upon legal laws applicable to the triggering event or to a particular case.

As depicted in FIG. 7, the priority or base date to be used for calculating a date for the action may be specified in field 732. A date generation formula for calculating the date to be associated with the action may be specified in fields 734. The type of the date (i.e., reminder date, due date, drop dead date, etc.) may be specified in field 736. Drop-down list menus may be provided to facilitate the selection process.

The user can add multiple actions for a rule by selecting “Add” button 738. A list of actions, a date generation formula associated with each action in the list, and a date type associated with each action specified for the rule are displayed in section 706. A particular selected action associated with a rule may be removed by selecting the action and then selecting “Remove” button 740.

Information for a rule may be saved by selecting “Save” button 742. An existing rule may be deleted by selecting “Delete” button 744. According to an embodiment of the present invention, various versions of a rule may be saved. For example, if information related to a pre-existing rule is modified, the modified information may be saved as a new version of the rule. New versions for a rule may be saved by selecting “Add New Version” button 746.

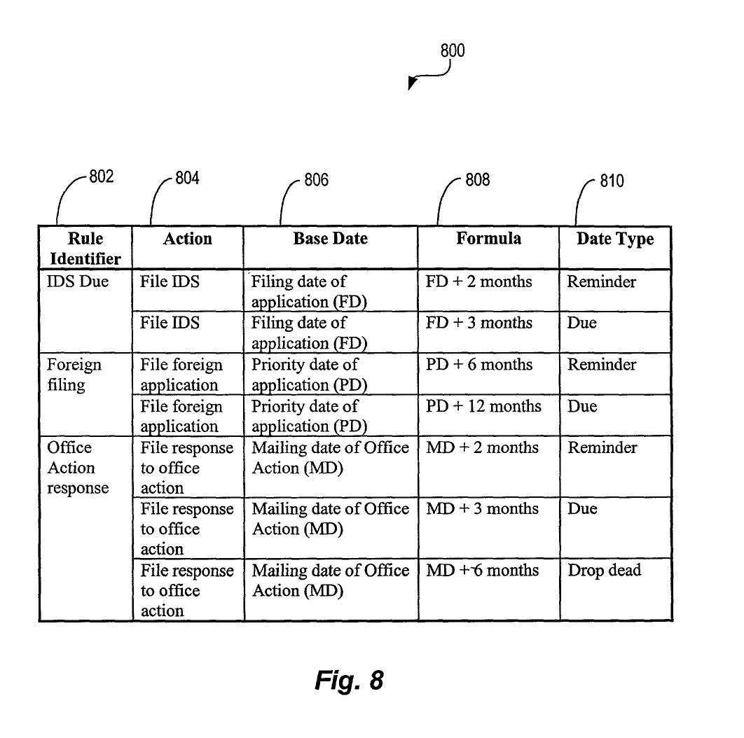

FIG. 8 depicts a simplified table 800 listing examples of rules that may be configured according to an embodiment of the present invention. Information related to three rules is depicted in FIG. 8. Rule identifiers are displayed in column 802. For each rule, one or more actions defined for the rule are shown in column 804. For each action, the base date to be used for generating a date for the action, a formula to be used for generating the date, and the type of the date associated with the action are displayed in columns 806, 808, and 810, respectively.

The rules depicted in FIG. 8 include an “IDS Due” rule, a “Foreign filing” rule, and an “Office Action response” rule. Two actions are defined for the “IDS Due” rule. The description for both actions is “File IDS.” Both actions use a filing date of an application as the base date. The date generated for the first action is of type “Reminder” and is calculated by adding two months to the base date. The date generated for the second action is of type “Due” date and is calculated by adding three months to the base date.

Two actions are defined for the “Foreign Filing” rule. The description for both actions is “File foreign application.” Both actions use a priority date of an application as the base date. The date generated for the first action is of type “Reminder” and is calculated by adding six months to the base date. The date generated for the second action is of type “Due” date and is calculated by adding twelve months to the base date.

Three actions are defined for the “Office Action response” rule. The description for all three actions is “File response to office action.” All three actions use a mailing date of an Office Action as the base date. The date generated for the first action is of type “Reminder” and is calculated by adding two months to the base date. The date generated for the second action is of type “Due” date and is calculated by adding three months to the base date. The date generated for the third action is of type “Drop dead” date and is calculated by adding six months to the base date.

The rules depicted in FIG. 8 are not intended to limit the scope of the present invention as recited in the claims. Additional rules may be defined as desired by users of the present invention.

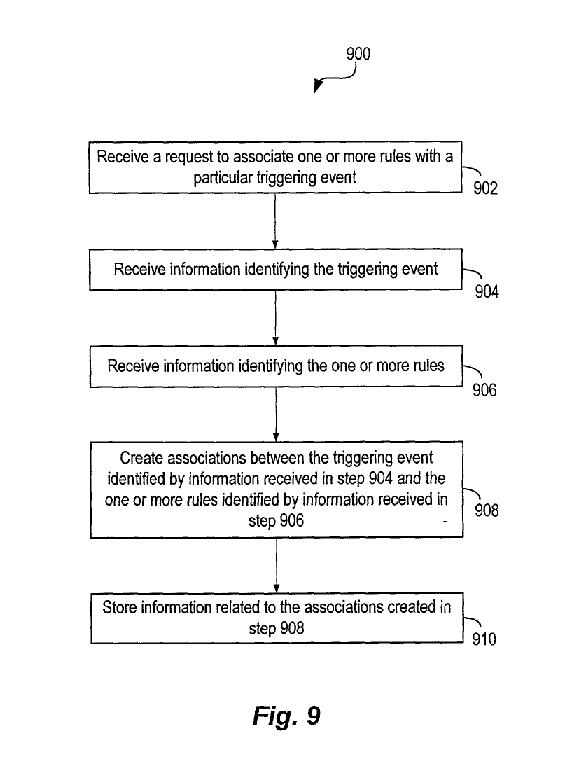

Referring back to FIG. 3, after triggering events and rules have been configured, one or more rules may be associated with each triggering event (step 306). Associations between triggering events and rules are generally based on laws and regulations applicable to cases managed by IP data processing system 100. The associations may also be based upon criteria provided by users of DS 105. FIG. 9 is a simplified high-level flowchart 900 showing a method of associating rules with a triggering event according to an embodiment of the present invention. Flowchart 900 depicted in FIG. 9 is merely illustrative of an embodiment incorporating the present invention and does not limit the scope of the invention as recited in the claims. One of ordinary skill in the art would recognize other variations, modifications, and alternatives.

As depicted in FIG. 9, the method is initiated when DS 105 receives a request to associate one or more rules with a particular triggering event (step 902). DS 105 receives information identifying a triggering event with which the rules are to be associated (step 904). DS then receives information identifying one or more rules to be associated with the triggering event received in step 904 (step 906). A particular version of a rule may also be associated with a triggering event. DS 105 then creates associations between the triggering event received in step 904 and the one or more rules received in step 906 (step 908). Information related to the associations between the triggering event and the rules may then be stored in a memory location accessible to DS 105 (e.g., the associations information may be stored in database 106) (step 910).

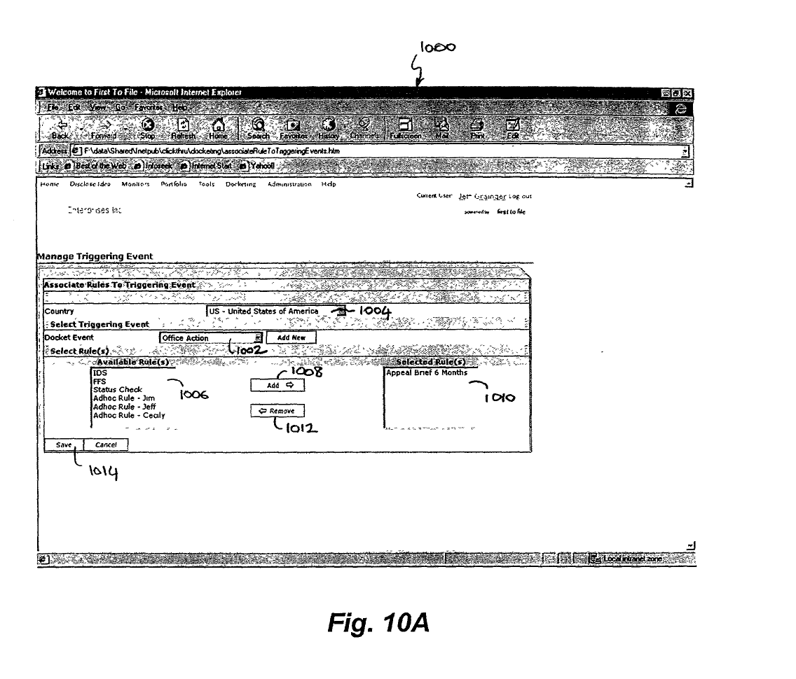

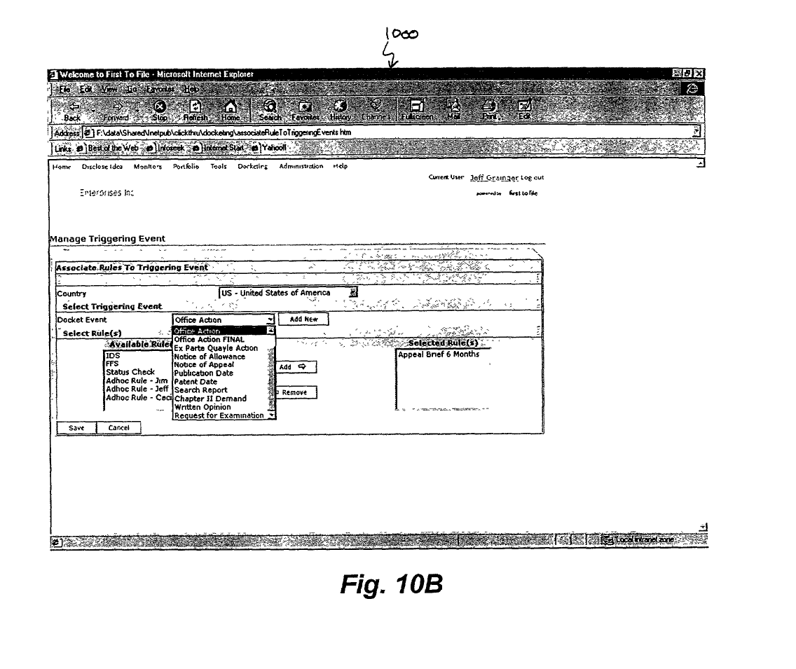

FIGS. 10A and 10B depict an example of a simplified user interface 1000 for associating one or more rules with a triggering event according to an embodiment of the present invention. User interface 1000 depicted in FIGS. 10A and 10B is merely illustrative of an embodiment of the present invention and does not limit the scope of the invention as recited in the claims. One of ordinary skill in the art would recognize other variations, modifications, and alternatives.

As depicted in FIG. 10A, the triggering event with which the rules are to be associated can be specified in field 1002. A drop-down menu is provided to facilitate the selection of a particular triggering event from pre-configured triggering events. The expanded drop-down menu is depicted in FIG. 10B showing multiple pre-configured triggering events including “Office Action,” “Office Action FINAL,” “Ex Parte Quayle Action,” “Notice of Allowance,” and the like. The user can select a particular triggering event from the list of triggering events. As previously indicated, a triggering event may refer to an event associated with a case or a change in data stored in a case data unit for a case. The country for which the triggering event and the associated rules are to be applied can be specified in field 1004.

Field 1006 displays a list of pre-configured rules that may be associated with the triggering event identified in field 1002. Using an input device such as a mouse, a user may select one or more rules to be associated with the triggering event from the displayed list. In order to associate a particular rule with the triggering event, a user may select the particular rule in field 1006 and then select “Add” button 1008. Upon selecting “Add” button 1008, the rules selected in field 1006 are transferred to field 1010, thereby indicating that the rule have been selected to be associated with the triggering event identified in field 1002. Rules that have been selected to be associated with the triggering event are displayed in field 1010. A user may deselect a previously selected rule by selecting the particular rule in field 1010 and then selecting “Remove” button 1012. Upon selecting “Remove” button 1012, the rules selected in field 1010 are transferred back to field 1006, thereby indicating that the rules are not to be associated with the triggering event.

Selecting “Save” button 1014 causes information related to the triggering event and the associated rules to be saved. As indicated above, the information related to the associations may be stored in database 106 or any other memory location accessible to DS 105. According to an embodiment of the present invention, associations configured by providers of DS 105 are stored in a system level storage (or system library) in database 106. Information configured by customers of DS 105 is stored in a customer level storage (or customer library) in database 106.

Referring back to FIG. 3, after one or more rules are associated with triggering events, recipients of the docketing messages generated by DS 105 are specified for each case (step 308). For each case, information identifying recipients of docketing messages generated in response to triggering events associated with the case may be stored in the case data unit corresponding to the case. One or more recipients may be specified for each case. The recipients may include a practitioner responsible for the case, a docketing specialist, or other entities associated with the case.

The triggering events and the associated rules are then used to automatically generate docketing messages alerting users of deadlines associated with cases (step 310). Further information related to generation of messages is described below.

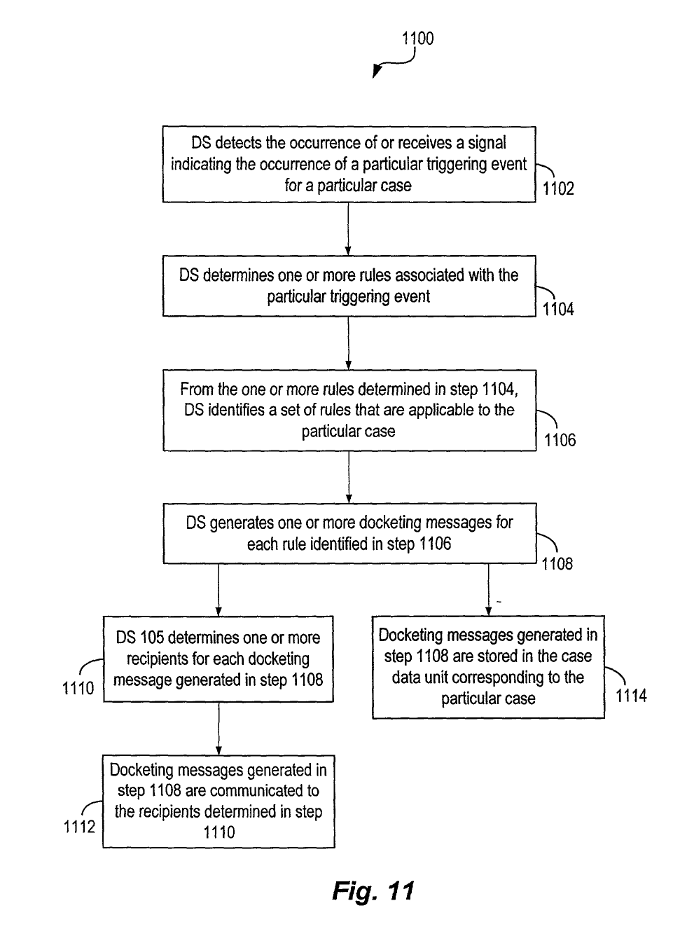

FIG. 11 is a simplified high-level flowchart 1100 depicting a method of generating docketing messages in response to a triggering event according to an embodiment of the present invention. Flowchart 1100 depicted in FIG. 11 is merely illustrative of an embodiment incorporating the present invention and does not limit the scope of the invention as recited in the claims. One of ordinary skill in the art would recognize other variations, modifications, and alternatives.

As depicted in FIG. 11, according to an embodiment of the present invention, the method is initiated when DS 105 detects the occurrence of or receives a signal indicating the occurrence of a particular triggering event for a particular case (step 1102). DS 105 may user various different techniques to detect the occurrence of the triggering event for the particular case. According to an embodiment of the present invention, DS 105 may track information stored by the case data unit corresponding to the particular case. DS 105 may detect the occurrence of a triggering event when some data, which has been defined as a triggering event, associated with the particular case has changed or been updated (i.e., specific changes in the case data unit information may signal occurrence of the triggering event). In other embodiments, DS 105 may receive a signal indicating the occurrence of a triggering event. The signal may be received from various sources. For example, the signal may be received from a docketing person who is responsible for tracking occurrences of triggering events. For example, a docketing person in a law firm may be responsible for tracking all correspondences received from and mailed to the USPTO, and for sending signals to DS 105 indicating occurrences of triggering events for one or more cases. The signal may also be received from one or more software applications that are configured to analyze documents received from or mailed to the USPTO (or any other intellectual property agency) and send a signal to DS 105 for documents that result in triggering events. If DS 105 is coupled to computer systems used by one or more patent offices, the signal may be received directly from the patent offices (e.g., from the USPTO) via electronic interfaces (e.g., PAIR) provided by the patent offices. In an automated workflow environment, DS 105 may automatically detect the occurrence of the particular event.

Upon detecting the occurrence of a triggering event in step 1102, DS 105 determines one or more rules associated with the particular triggering event (step 1104). The one or more rules determined in step 1104 may include rules configured by customers of IP data processing system 100 or rules configured by providers of DS 105. As previously stated, information related to the triggering event and rules associated with the triggering event are stored in a memory location accessible to DS 105 (e.g., in database 106).

From the one or more rules determined in step 1104, DS 105 then identifies a set of rules that are applicable to the particular case (step 1106). According to an embodiment of the present invention, DS 105 is configured to sift through the rules associated with the triggering event to select only those rules that apply to the particular case. Whether or not a rule is applicable for the particular case depends on the filter criteria defined for the rule. As described previously, the filter criteria for a rule may be specified when the rule is created (e.g., information specified in sections 702 and 704 of user interface 700 depicted in FIG. 7). According to an embodiment of the present invention, for each rule in the one or more rules identified in step 1104, DS 105 determines if the filter criteria defined for the rule matches the case information stored in the case data unit corresponding to the particular case. A rule is deemed to be applicable to the particular case, and is included in the set of rules identified in step 1106, if the case information associated with the particular case contains attributes that match or satisfy the filter criteria specified for the rule. It should be apparent that various other techniques may also be used to identify the set of rules in alternative embodiments of the present invention. For example, if the filter criteria for a rule specifies that the rule is to apply to a pending U.S. utility patent application, then the rule will be selected in step 1106 if the particular case is a pending U.S. utility patent application.

DS 105 then generates one or more docketing messages for each rule in the set of rules identified in step 1106 (step 1108). According to an embodiment of the present invention, each docketing message comprises information identifying an action to be performed in response to the particular triggering event, a date associated with the action, and information identifying the type of the date. As previously stated, for each rule, information used for generating one or more docketing messages for the rule is specified when the rule is configured. For example, according to an embodiment of the present invention, information specified in section 706 of user interface 700 depicted in FIG. 7 is used to generate the one or more docketing messages. DS 105 calculates the date for each message using the base date and the date generation formula associated with the action for the rule. The base date may correspond to a date associated with the particular triggering event (e.g., if the triggering event corresponds to an Office Action received from the USPTO, the base date for an action may correspond to the mailing date of the Office Action) or to a date associated with the case and stored in the case data unit (e.g., if the triggering event corresponds to filing of a patent application, the base date for an action related to IDS filings may correspond to the date of filing of the application).

DS 105 then determines one or more recipients for each docketing message generated in step 1108 (step 1110). Information identifying the recipients may be stored in the case data unit for the particular case. The docketing messages generated in step 1108 are then communicated to the appropriate recipients determined in step 1110 (step 1112). According to an embodiment of the present invention, the docketing messages are communicated to client computers used by the recipients determined in step 1110. For example, docketing messages generated in response to receiving an office action may be communicated to a client system of a practitioner handling the particular case and to a partner in charge of the case. The docketing messages may be communicated to the recipients using various different communication channels including emails, faxes, instant messages, pages, telephone calls, electronic docket reports, electronic to-do-lists, and other information communication techniques.

According to an embodiment of the present invention, the docketing messages generated in step 1108 are also stored in the case data unit corresponding to the particular case for which the messages have been generated (step 1114). Accordingly, a user can access information stored in the case data unit to get information about all docketing messages that have been generated for the case corresponding to the case data unit.

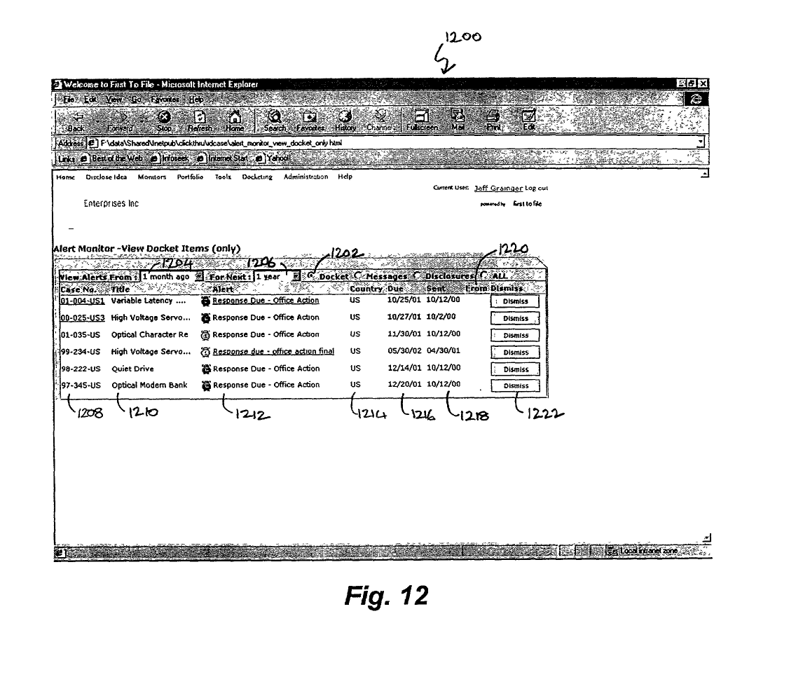

FIG. 12 depicts an example of a simplified user interface 1200 for outputting docketing messages to a user according to an embodiment of the present invention. User interface 1200 depicted in FIG. 12 is merely illustrative of an embodiment of the present invention and does not limit the scope of the invention as recited in the claims. One of ordinary skill in the art would recognize other variations, modifications, and alternatives.

User interface 1200 may be used to display docketing messages, other non-docketing messages, disclosures, or all of the aforementioned categories. As depicted in FIG. 12, user interface 1200 displays docketing messages (as indicated by selection of radio button 1202) for a user “Jeff Grainger.” A time period specified by a start time and an end time may be specified. The start time for the time period may be specified in field 1204 and an end time may be specified in field 1206. Only those docketing messages having dates that fall within the time period are displayed.

For each docketing message, user interface 1200 displays information identifying the case for which the docketing message was generated. As depicted in FIG. 12, the case identification information for a case includes a case number 1208 and a title 1210 for the case. For each docketing message a description of the action to be performed 1212, the country 1214 associated with the case, the date 1216 associated with the action, and the date 1218 when the docketing message was generated and communicated to the recipient is displayed. According to an embodiment of the present invention, each docketing message displayed in user interface 1200 may be color-coded to indicate the degree of urgency of the docketing message. For example, docketing messages that comprise “drop dead dates” may be displayed in red color to emphasize their importance, docketing messages that comprise “reminder dates” and “due dates” may be displayed in various different colors.

Information 1220 identifying an origination point of the docketing message may also be displayed. The recipient of a docketing message may dismiss (or de-docket) a particular docketing message by selecting a “Dismiss” button 1222 corresponding to the docketing message. Dismissing a docketing message results in removal of the docketing message from the recipient's docket. According to an embodiment of the present invention, only docketing messages containing soft dates (i.e., docketing messages comprising reminder dates) can be dismissed by a recipient. In this embodiment, the recipient cannot dismiss docketing messages that contain hard dates (i.e., due date or drop dead dates). According to an embodiment of the present invention, a docketing message may be dismissed when DS 105 determines that the action described by the docketing message has been performed. Clicking on an case displayed in user interface 1200 may open another interface displaying data and documents stored by the case data unit related to the selected case.

As shown above, user interface 1200 provides an integrated interface for displaying docketing messages, other messages (e.g., in-box messages, task lists, mail messages, etc.), invention disclosures, and the like. Accordingly, user interface 1200 eliminates the need to have separate user interfaces for mail, task lists, docket reminders, etc. which can be inefficient and can even lead to deficiencies in communication. Further, unlike conventional docketing systems that generate a hard copy docketing report that is then routed to the practitioner in charge of a case, according to the present invention, the docketing messages are automatically generated and electronically communicated to the user.

As described above, triggering events and rules may be configured by providers by IP data processing system 100 or may be configured by users who use services provided by IP data processing system 100. In order to maintain the integrity of the docketing system, DS 105 performs special processing when a particular triggering event or rule is to be modified or deleted.

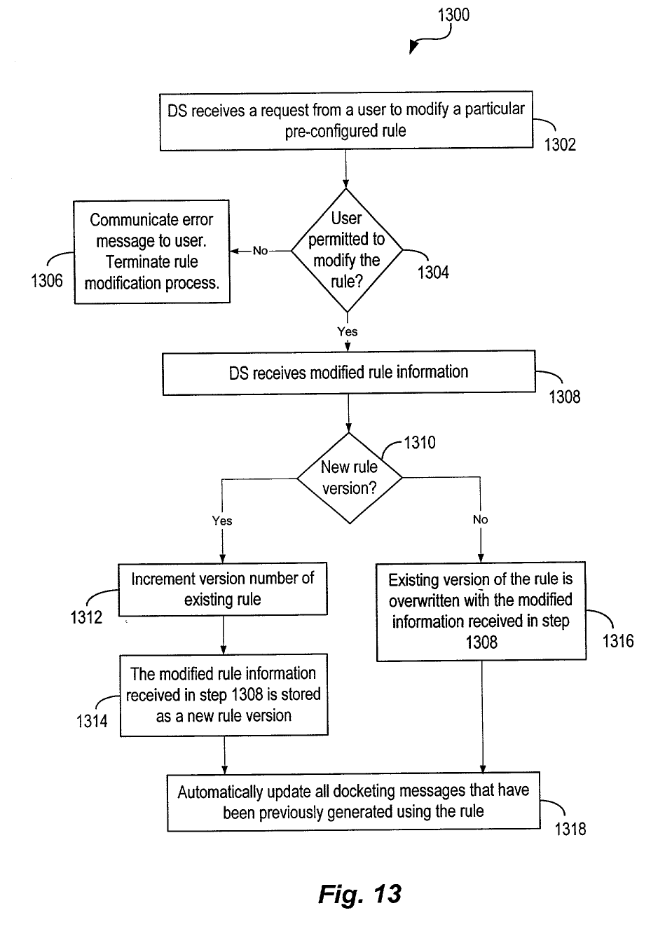

Information related to a rule may be modified for various reasons, e.g., to add new actions, to change the description for a pre-defined action, to change the formula for calculating a date for an action associated with the rule, to change the rule name, to change the base date to be used, and the like. FIG. 13 is a simplified high-level flowchart 1300 showing a method of modifying a previously configured rule according to an embodiment of the present invention. Flowchart 1300 depicted in FIG. 13 is merely illustrative of an embodiment incorporating the present invention and does not limit the scope of the invention as recited in the claims. One of ordinary skill in the art would recognize other variations, modifications, and alternatives.

The method is initiated when DS 105 receives a request from a user to modify a particular pre-configured rule (step 1302). DS 105 then determines if the user from whom the request is received is permitted to modify the particular rule (step 1304). If the user is not permitted to modify the particular rule, an error message is communicated to the user and the rule modification process is terminated (step 1306). If the user is allowed to modify the rule, DS 105 then receives the modified rule information (step 1308).

DS 105 then determines if the modified rule information received in step 1308 is to be saved as a new rule version (step 1310). As described above, according to an embodiment of the present invention, the user may specify that the modified information is to be stored as a new version by selecting “Add New Version” button 746 depicted in FIG. 7. If the modified rule information is to be saved as a new rule version, the version number of the rule is incremented (step 1312), and the modified information is stored as a new version (step 1314). If the modified rule information is not to be saved as a new rule version, the existing version of the rule is overwritten with the modified information (step 1316).

DS 105 uses the modified information to automatically update all docketing messages that may have been previously generated using the rule (step 1318). According to an embodiment of the present invention, if a new version of the rule is added, then only those docketing messages for cases that are filed after the end date of the old version of the rule are updated. In this manner the integrity of the docketing system is maintained.

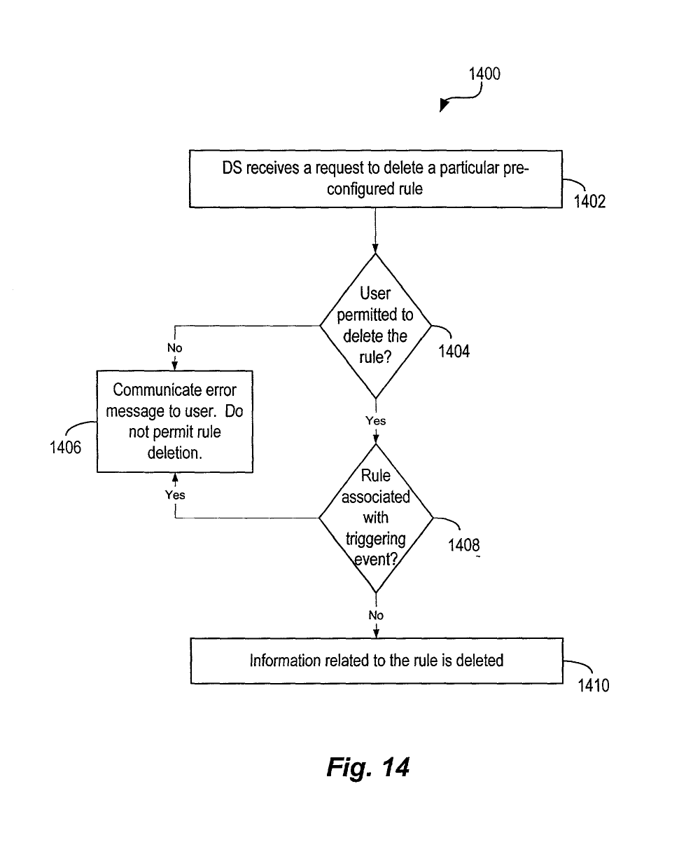

FIG. 14 is a simplified high-level flowchart 1400 showing a method of deleting a previously configured rule according to an embodiment of the present invention. Flowchart 1400 depicted in FIG. 14 is merely illustrative of an embodiment incorporating the present invention and does not limit the scope of the invention as recited in the claims. One of ordinary skill in the art would recognize other variations, modifications, and alternatives.

The method is initiated when DS 105 receives a request to delete a particular pre-configured rule (step 1402). DS 105 then determines if the user from whom the request is received is permitted to delete the particular rule (step 1404). If the user is not permitted to delete the particular rule, an error message is communicated to the user and the rule deletion process is terminated (step 1406). If the user is permitted to delete the rule, DS 105 then determines if the rule to be deleted is associated with any triggering event (step 1408). If the rule is associated with any triggering event, an error message is communicated to the user and the rule deletion is not permitted (step 1406). In this manner, the integrity of the docketing system is maintained. If the rule to be deleted is not associated with any triggering event, then information related to the rule is deleted (step 1410). All actions and other information related to the rule are also deleted as part of step 1410.

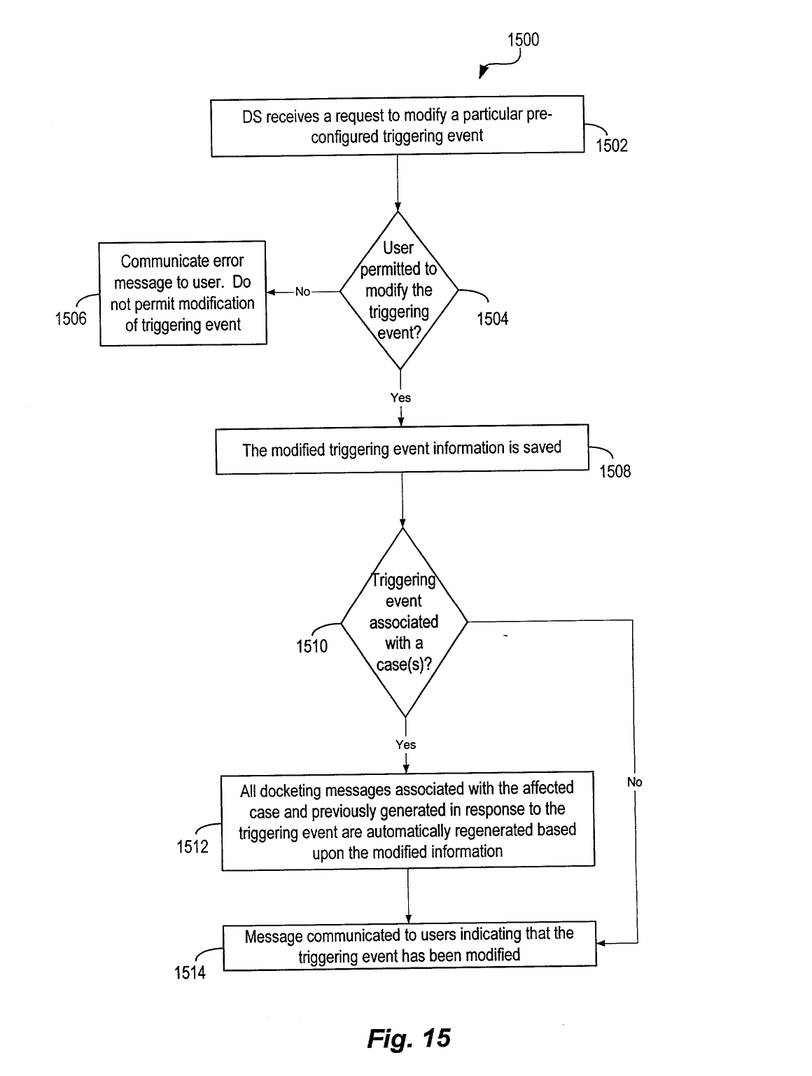

FIG. 15 is a simplified high-level flowchart 1500 depicting a method of modifying a previously configured triggering event according to an embodiment of the present invention. The triggering event may be modified to add or remove rules associated with the triggering event. Flowchart 1500 depicted in FIG. 15 is merely illustrative of an embodiment incorporating the present invention and does not limit the scope of the invention as recited in the claims. One of ordinary skill in the art would recognize other variations, modifications, and alternatives.

According to an embodiment of the present invention, the method is initiated when DS 105 receives a request to modify a particular pre-configured triggering event (step 1502). DS 105 then determines if the user from whom the request is received is permitted to modify the particular triggering event (step 1504). If the user is not permitted to modify the particular triggering event, an error message is communicated to the user and the triggering event modification process is terminated (step 1506). If the user is allowed to modify the triggering event, then the modified triggering event information is saved to a memory location accessible to DS 105 (step 1508). DS 105 then determines if the triggering event that is modified is associated with any case (step 1510). If the triggering event is not associated with any case processing continues with step 1514. If DS 105 determines in step 1510 that the triggering event is associated with a case, then all docketing messages associated with the affected case and previously generated in response to the triggering event are automatically regenerated based upon the modified information (step 1512). According to an embodiment of the present invention, a message may be communicated to users and customers of DS 105 indicating that the triggering event has been modified (step 1514).

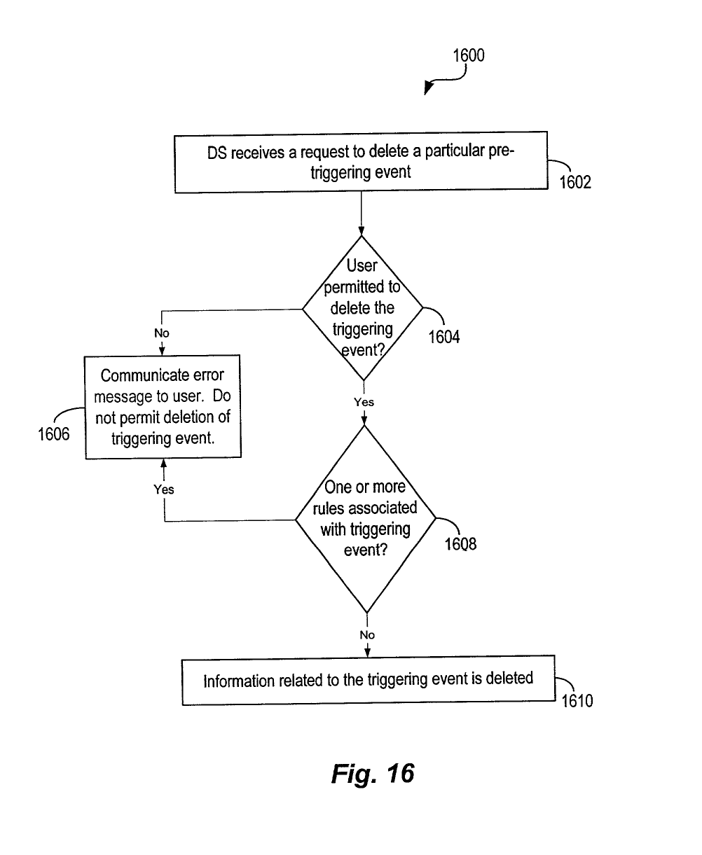

FIG. 16 is a simplified high-level flowchart 1600 showing a method of deleting a previously configured triggering event according to an embodiment of the present invention. Flowchart 1600 depicted in FIG. 16 is merely illustrative of an embodiment incorporating the present invention and does not limit the scope of the invention as recited in the claims. One of ordinary skill in the art would recognize other variations, modifications, and alternatives.

According to an embodiment of the present invention, the method is initiated when DS 105 receives a request to delete a particular triggering event (step 1602). DS 105 then determines if the user from whom the request is received is permitted to delete the particular triggering event (step 1604). If the user is not permitted to delete the particular triggering event, an error message is communicated to the user and the user is not permitted to delete the triggering event (step 1606). If the user is permitted to delete the rule, DS 105 then determines if one or more rules are associated with the triggering event to be deleted (step 1608). If one or more rules are associated with the triggering event, an error condition is indicated and deletion of the triggering event is not permitted (step 1606). If no rules are associated with the triggering event, then information related to the triggering event is deleted (step 1610).

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A computer-implemented method of generating a message for a first intellectual property case, the method comprising:
storing information related to a plurality of intellectual property cases on a computer-readable medium, the plurality of intellectual property cases including the first intellectual property case;
receiving a signal indicating occurrence of an event related to the first intellectual property case;
responsive to receiving the signal, identifying one or more rules associated with the event;
identifying at least a first rule from the one or more rules based upon filter criteria information associated with the one or more rules and based upon information related to the first intellectual property case stored on the computer-readable medium;
generating at least one message using the at least first rule, the message identifying an action to be performed in response to the event and identifying a date associated with the action; and
communicating the at least one message to a first designated client system.

2. The method of claim 1 wherein the plurality of intellectual property cases includes patent cases and the first intellectual property case is a patent application case.

3. The method of claim 1 wherein the plurality of intellectual property cases includes trademark cases and copyright cases.

4. The method of claim 1 wherein storing information related to the plurality of intellectual property cases on the computer-readable medium comprises:
for each intellectual property case, storing the information related to the intellectual property case in a case data unit, wherein the case data unit stores data related to the intellectual property case and one or more documents related to the intellectual property case.

5. The method of claim 1 wherein the signal indicating occurrence of the event related to the first intellectual property case is generated responsive to a change in the information related to the first intellectual property case.

6. The method of claim 1 wherein identifying the at least first rule from the one or more rules based upon the filter criteria information comprises:
determining a set of rules from the one or more rules associated with the event, wherein a rule from the one or more rules is included in the set of rules if the filter criteria associated with the rule is satisfied by the information related to the first intellectual property case, the set of rules including the at least first rule.

7. The method of claim 6 wherein:
the plurality of intellectual property cases includes patent cases and the first intellectual property case is a patent application case; and
the filter criteria associated with each rule in the one or more rules comprises a criterion related to filing status of a patent case, a criterion related to a type of the patent case, and a criterion related to priority information for a patent case.

8. The method of claim 1 wherein generating the at least one message using the at least first rule comprises:
determining an action associated with the at least first rule;
determining a date generation formula associated with the action and a base date used by the date generation formula;
applying the date generation formula to the base date to generate the date associated with the action; and
including information indicating the action associated with the at least first rule and the date generated by applying the date generation formula in the at least one message.

9. The method of claim 1 wherein communicating the at least one message to the first designated client system comprises:
determining one or more users associated with the first intellectual property case from information related to the first intellectual property case;
from the one or more users, determining a first user who is designated to receive the at least one message generated using the first rule;
communicating the at least one message to a system used by the first user.

10. The method of claim 9 wherein communicating the at least one message to the system used by the first user comprises:
sending an electronic mail message to first user, the electronic mail message including the at least one message.

11. A system for generating a message for a first intellectual property case, the method comprising:
a processor; and
a memory coupled to the processor, the memory configured to store:
information related to a plurality of intellectual property cases, the plurality of intellectual property cases including the first intellectual property case; and
a computer program;
wherein the processor is operative with the computer program to:
receive a signal indicating occurrence of an event related to the first intellectual property case;
identify one or more rules associated with the event responsive to receiving the signal;
identify at least a first rule from the one or more rules based upon filter criteria information associated with the one or more rules and based upon information related to the first intellectual property case stored in the memory;
generate at least one message using the at least first rule, the message identifying an action to be performed in response to the event and identifying a date associated with the action; and
communicate the at least one message to a first designated client system.

12. The system of claim 11 wherein:
the plurality of intellectual property cases includes patent cases and the first intellectual property case is a patent application case; and
for each intellectual property case, the information related to the intellectual property case is stored in a case data unit, wherein the case data unit stores data related to the intellectual property case and one or more documents related to the intellectual property case.

13. The system of claim 11 wherein:
the plurality of intellectual property cases includes patent cases and the first intellectual property case is a patent application case; and
the processor is operative with the computer program to determine a set of rules from the one or more rules associated with the event, wherein a rule from the one or more rules is included in the set of rules if the filter criteria associated with the rule is satisfied by the information related to the first intellectual property case, the set of rules including the at least first rule.

14. The system of claim 11 wherein the processor is operative with the computer program to:
determine an action associated with the at least first rule;
determine a date generation formula associated with the action and a base date used by the date generation formula;
apply the date generation formula to the base date to generate the date associated with the action; and
include information indicating the action associated with the at least first rule and the date generated by applying the date generation formula in the at least one message.

15. The system of claim 11 wherein the processor is operative with the computer program to:
determine one or more users associated with the first intellectual property case from information related to the first intellectual property case;
from the one or more users, determine a first user who is designated to receive the at least one message generated using the first rule;
communicating the at least one message to a system used by the first user.

16. A docketing system comprising:
a storage module, the storage module configured to store information related to a plurality of intellectual property cases on a computer-readable medium, the plurality of intellectual property cases including the first intellectual property case, the information related to each intellectual property case in the plurality of intellectual property cases including data related to the intellectual property case and data related to one or more documents related to the intellectual property case;
a processing module, the processing module configured to:
receive a signal indicating occurrence of an event related to the first intellectual property case;
identify one or more rules associated with the event;
identify at least a first rule from the one or more rules based upon filter criteria information associated with the one or more rules and based upon information related to the first intellectual property case stored on the computer-readable medium; and
generate at least one message using the at least first rule, the message identifying an action to be performed in response to the event and identifying a date associated with the action; and
a communications module configured to communicate the at least one message to a first designated client system.

17. A computer program stored on a computer-readable storage medium for generating a message for a first intellectual property case, the computer program product comprising:
code for storing information related to a plurality of intellectual property cases on a computer-readable medium, the plurality of intellectual property cases including the first intellectual property case;
code for receiving a signal indicating occurrence of an event related to the first intellectual property case;
code for identifying one or more rules associated with the event;
code for identifying at least a first rule from the one or more rules based upon filter criteria information associated with the one or more rules and based upon information related to the first intellectual property case stored on the computer-readable medium;
code for generating at least one message using the at least first rule, the message identifying an action to be performed in response to the event and identifying a date associated with the action; and
code for communicating the at least one message to a first designated client system.

18. The computer program product of claim 17 wherein the code for identifying the at least first rule from the one or more rules based upon the filter criteria information comprises:
code for determining a set of rules from the one or more rules associated with the event, wherein a rule from the one or more rules is included in the set of rules if the filter criteria associated with the rule is satisfied by the information related to the first intellectual property case, the set of rules including the at least first rule.

19. The computer program product of claim 17 wherein the code for generating the at least one message using the at least first rule comprises:
code for determining an action associated with the at least first rule;
code for determining a date generation formula associated with the action and a base date used by the date generation formula;
code for applying the date generation formula to the base date to generate the date associated with the action; and
code for including information indicating the action associated with the at least first rule and the date generated by applying the date generation formula in the at least one message.

20. The computer program product of claim 17 wherein the code for communicating the at least one message to the first designated client system comprises:
code for determining one or more users associated with the first intellectual property case from information related to the first intellectual property case;
code for determining a first user from the one or more users who is designated to receive the at least one message generated using the first rule; and
code for communicating the at least one message to a system used by the first user.
